(19) United States
(12) Patent Application Publication
(10) Pub. No.: US 2004/0018398 A1
(43) Pub. Date: Jan. 29, 2004

(54) Auxiliary battery

(76) Inventor: Kyoung Hae Kim, Los Angeles, CA (US)

Correspondence Address: Kyoung Hae Kim, 146 Douglas St. #10, Los Angeles, CA, 90026, US

(21) Appl. No.: 10/200,625

(22) Filed: Jul. 23, 2002

(51) Int. Cl. H01M 16/00

(52) U.S. Cl. 429/9; 429/110

(57) ABSTRACT

This auxiliary battery can help main battery which is exhausted temporarily and can help to start up immediately. We can use only just button instead of jump cable so save effort and does not need to make hand dirty for business man wearing suit to go to do their business.

### BACKGROUND OF THE INVENTION

I. Field of the Invention

This invention is a part of auto vehicle and help main battery. In case of being temporarily exhausted the main battery, without any help this auxiliary battery can start up the auto vehicle and auto vehicle can become normal condition.

II. Description of the Prior Art

The auxiliary battery is so smaller than main battery that can be set up inside the dashboard. How smaller the auxiliary battery is 1/18-1/19 than main battery. In case of emergency situation and hurry up should go somewhere after solving the problem (battery exhausted), the auxiliary battery is really needed.

### SUMMARY OF THE INVENTION

This auxiliary battery can help main battery which is exhausted temporarily and can start up auto vehicle immediately. We can use only just button so save effort and safety and doesn't need to make hand dirty.

When the sun sets and darkness spreads around, we could not find out the kind person to lend jump cable and their effort, we can use the auxiliary battery instead of jump cable.

### BRIEF DESCIPTION OF THE DRAWING

This auxiliary battery is so smaller than main battery that can be set up easy way to proper place. We can use only just button instead of jump cable.

FIG. 1. is the connection of the auxiliary battery (from auxiliary battery, though button, to the main battery)

FIG. 2 is using fuse, fuse go to the fuse box.

FIG. 3 is smaller than main battery.

### DESCRIPTION OF THE PERFERRED EMBODIMENT

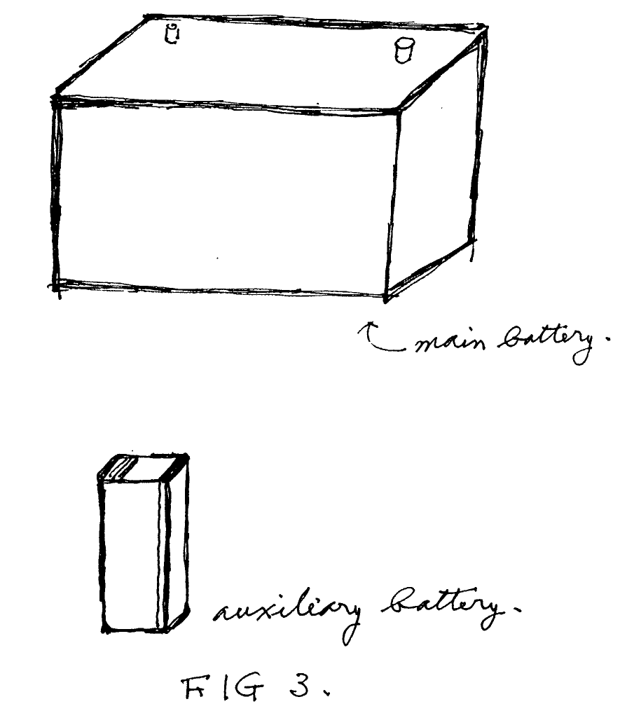

Referring to FIG. 3, the preferred embodiment of the present invention is very proper, because size is small to be set up some place.

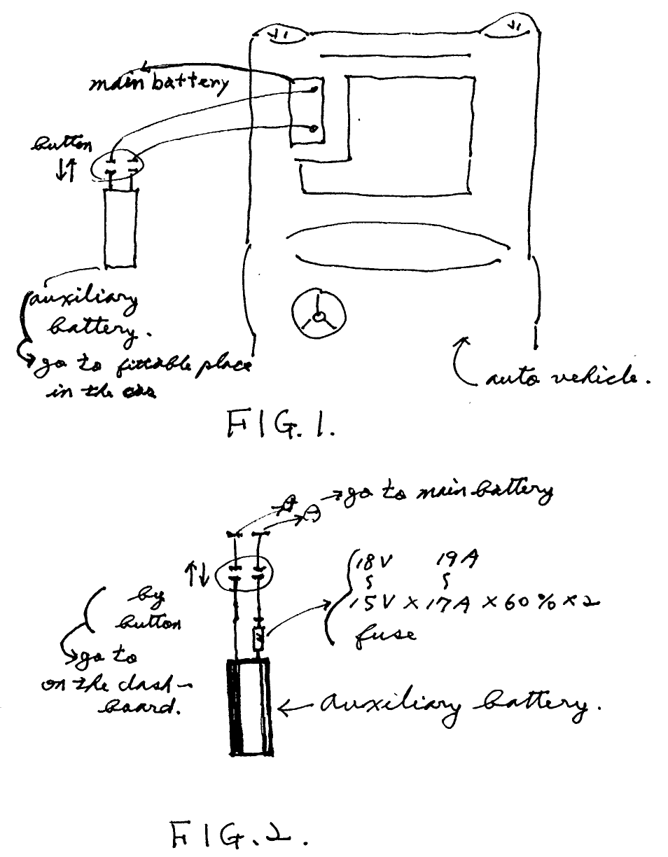

Referring to FIG. 1 and FIG. 2, the auxiliary battery provides impact current to the main battery which is exhausted temporarily by press the button on the dashboard so that the auto vehicle can start it up, if turn on the starting key.

While a preferred embodiment of the invention has been described and illustrated for purposes of examples, spirit of the present invention that is defined by the claim that will follow:

What is claimed is:

1. In case of being temporarily exhausted the main batter, without any help this auxiliary battery help the main battery, can start up the auto vehicle and auto vehicle can become normal condition.
